(19) United States
(12) Patent Application Publication
(10) Pub. No.: US 2013/0083538 A1
(43) Pub. Date: Apr. 4, 2013

(54) LED LAMP

(71) Applicant: Tsutomu TOTANI, Aichi (JP)

(72) Inventor: Tsutomu TOTANI, Aichi (JP)

(73) Assignee: Beat-Sonic Co., Ltd., Aichi (JP)

(21) Appl. No.: 13/609,436

(22) Filed: Sep. 11, 2012

(30) Foreign Application Priority Data
Oct. 3, 2011 (JP) P2011-219351

(51) Int. Cl. F21V 1/00

(52) U.S. Cl. 362/277

(57) ABSTRACT

An LED lamp includes a housing having a front end side formed into a cup shape and a rear end to which a cap is fixed, the cup-shaped portion having an inner peripheral surface formed with a reflection layer and an open end, a cap fixed to the rear end of the housing, an LED chip fixed to a bottom of the cup-shaped portion, a lighting circuit incorporated in the housing to supply electric power to the LED chip, the lighting circuit and the cap being electrically connected to each other, and a hood which is mounted to the open end of the cup-shaped portion so as to be movable forward and rearward in a direction of an imaginary center line of the cup-shaped portion.

### CROSS-REFERENCE TO RELATED APPLICATIONS

This application is based upon and claims the benefit of priority from the prior Japanese Patent Application No. 2011-219351 filed on Oct. 3, 2011, the entire contents of which are incorporated herein by reference.

### BACKGROUND

1. Technical Field

The present disclosure relates to an LED lamp incorporating an LED chip serving as a light source.

2. Related Art

Japanese Patent Application Publication No. JP-A-2011-175978 discloses an LED lamp suitable for use as a light source of spotlights instead of halogen bulbs. The disclosed LED lamp includes a housing having a front end side formed into a cup shape. A cap is fixed to a rear end of the housing. An LED chip is fixed to a bottom of a cup-shaped portion of the housing. Furthermore, a lighting circuit is incorporated in the housing to supply electric power to the LED chip. The cap and the lighting circuit are electrically connected to each other.

In the LED lamps of the above-described type, when a depth of the cup-shaped portion is excessively small, a large amount of light emitted from the LED chip is reflected on an inner peripheral surface of the cup-shaped portion to leak around the LED lamp through the open end of the cup-shaped portion. As a result, a person around the LED lamp feels excessively dazzling and sometimes feels pain in his or her eyes.

On the other hand, an amount of light leaking around the LED lamp through the open end of the cup-shaped portion is decreased when the depth of the cup-shaped portion is excessively large. In this case, however, the LED lamp reduces gorgeousness it creates as lighting equipment.

### SUMMARY

An object of the disclosure is to provide an LED lamp in which an amount of light emitted around the LED lamp through the open end of the cup-shaped portion is suitably adjustable.

The present disclosure provides an LED lamp comprising a housing having a front end side formed into a cup shape and a rear end to which a cap is fixed, the cup-shaped portion having an inner peripheral surface formed with a reflection layer and an open end, a cap fixed to the rear end of the housing, an LED chip fixed to a bottom of the cup-shaped portion, a lighting circuit incorporated in the housing to supply electric power to the LED chip, the lighting circuit and the cap being electrically connected to each other, and a hood which is mounted to the open end of the cup-shaped portion so as to be movable forward and rearward in a direction of an imaginary center line of the cup-shaped portion.

According to the above-described configuration, the hood is attached to the open end of the cup-shaped portion so as to be movable forward and rearward. Consequently, an amount of light emitted around the LED lamp through the cup-shaped portion can be adjusted by moving the hood forward and rearward.

### BRIEF DESCRIPTION OF THE DRAWINGS

In the accompanying drawings:

FIG. 1 is a sectional view of an LED lamp according to a first embodiment;

FIG. 2 is a perspective view of a hood attached to the LED lamp;

FIG. 3 is a sectional view of an LED lamp according to a second embodiment;

FIG. 4 is a perspective view of a hood attached to the LED lamp in the second embodiment;

FIG. 5 is a perspective view of a hood attached to the LED lamp in a third embodiment;

FIG. 6 is a sectional view of an LED lamp according to a fourth embodiment;

FIG. 7 is a perspective view of a hood attached to the LED lamp in the fourth embodiment;

FIG. 8 is a perspective view of an LED lamp according to a fifth embodiment;

FIG. 9 is a perspective view of a hood attached to an LED lamp according to a sixth embodiment;

FIG. 10 is a perspective view of a hood attached to an LED lamp according to a seventh embodiment;

FIG. 11 is a perspective view of a hood attached to an LED lamp according to an eighth embodiment; and

FIG. 12 is a perspective view of a hood attached to the LED lamp in the eighth embodiment.

### DETAILED DESCRIPTION

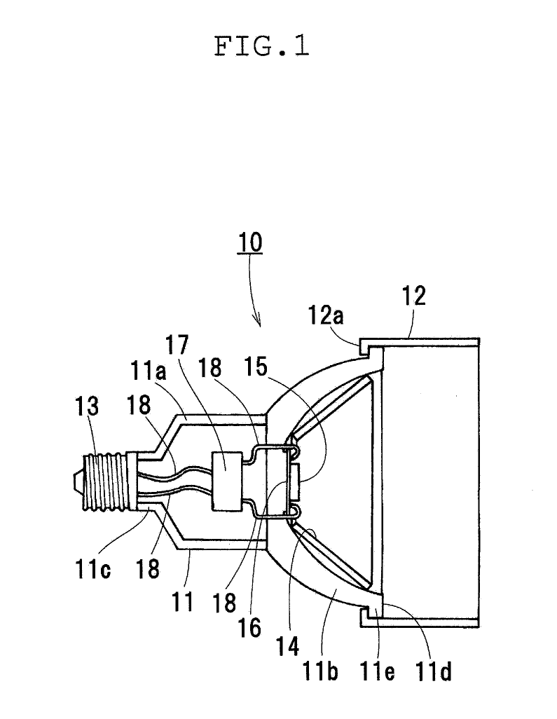

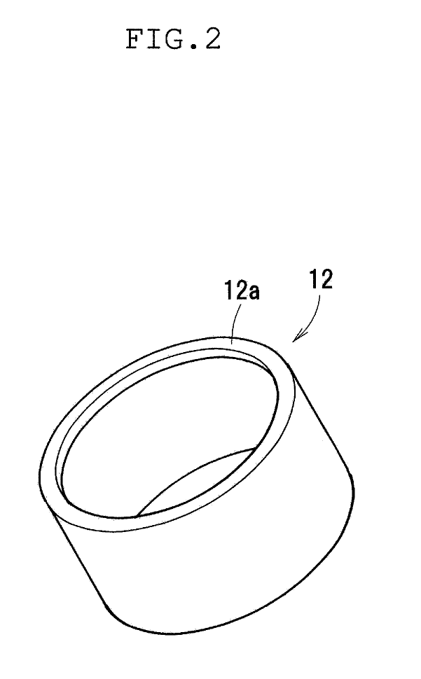

Several embodiments will be described with reference to the accompanying drawings. Referring to FIG. 1, an LED lamp 10 according to a first embodiment is shown. FIG. 2 shows a hood 12 which is to be attached to the LED lamp 10. The LED lamp 10 includes a housing 11 made of a metallic material, such as aluminum, having high heat conductivity and high heat radiation performance and an cylindrical hood 12 having two open ends.

The housing 11 includes a cylindrical housing body 11a, a cup-shaped portion 11b provided on a front end of the housing body 11a and a smaller-diameter cylindrical portion 11c provided on a rear end of the housing body 11a. A cap 13 having a shape and dimensions according to the International Standard is secured to the smaller-diameter cylindrical portion 11c.

A reflection layer 14 is formed on an inner periphery of the cup-shaped portion 11b of the housing 11. A module substrate 16 on which an LED chip 15 is mounted is fixed to a central bottom of the cup-shaped portion 11b. Furthermore, a lighting circuit 17 supplying electric power to the LED chip 15 is incorporated in the housing 11a. The lighting circuit 17 and the module substrate 16 are electrically connected to each other by a lead wire 18. The lighting circuit 17 and the cap 13 are electrically connected to each other by another lead wire 18.

The cup-shaped portion 11b of the housing 11 has an open end 11d having a flange 11e which is formed over an entire periphery of the open end 11d so that the flange 11e protrudes radially outward with respect to the cup-shaped portion 11b. On the other hand, the hood 12 has a rear end opening having a ring-shaped hook piece 12a which is formed over an entire periphery of the rear end opening of the hood 12 so that the hook piece 12a protrudes radially inward with respect to the hood 12.

The hood 12 is an opaque resin molding and has an inner diameter that is sized so that the hood 12 is slidably and rotatably fitted with the flange 11e. The hood 12 is attached to the open end 11d of the cup-shaped portion 11b so as to cover the housing 11 from the rear end side of the housing 11 and so as to be movable forward and rearward in a front-rear direction while being slid on the outer periphery of the flange 11e along an imaginary center line or an axis of the cup-shaped portion 11b. Since the hook piece 12a engages the flange 11e at a forward end of the hood 12, the hood 12 can be prevented from dropping off from the open end 11d of the cup-shaped portion 11b when moved forward.

According to the LED lamp 10 of the first embodiment, the hood 12 is attached to the open end of the cup-shaped portion 11b of the housing 11 so as to be movable forward and rearward. Accordingly, an amount of light emitted around the LED lamp 10 through the open end 11d of the cup-shaped portion 11 can suitably be adjusted when the hood 12 is moved forward or rearward.

The hood 12 can be prevented from dropping off from the open end 11d of the cup-shaped portion 11b by the engagement of the hook piece 12a with the flange 11e when the hood 12 is attached to the open end 11d of the cup-shaped portion 11b. Furthermore, the hood 12 can be detached from the housing 11 when moved rearward. Consequently, attachment and detachment of the hood 12 can be carried out more easily.

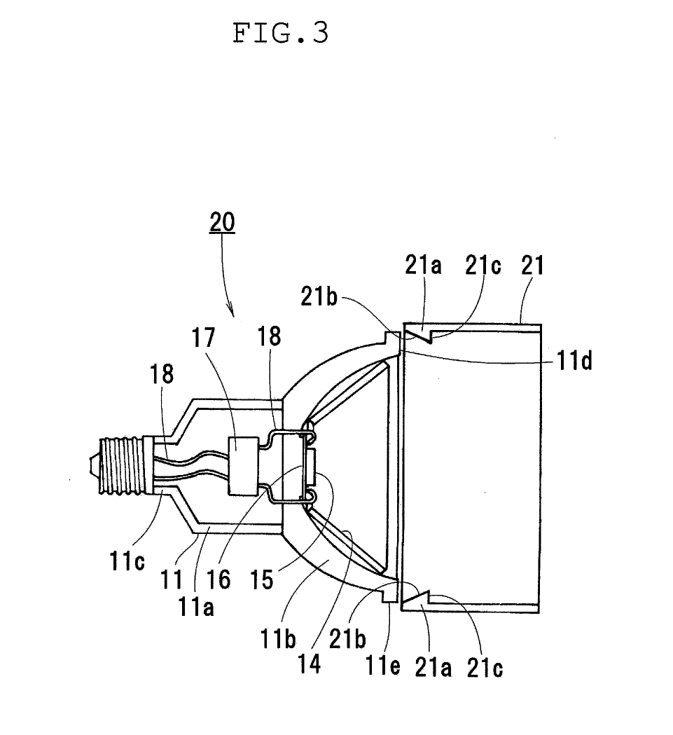

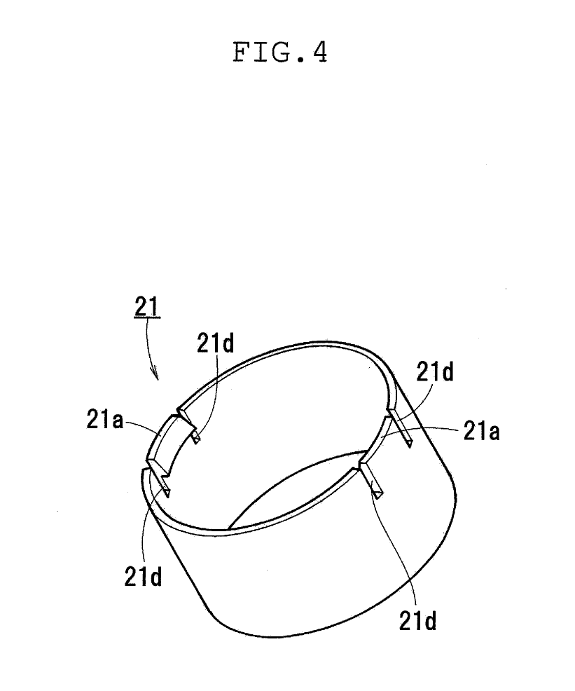

FIG. 3 illustrates an LED lamp 20 according to a second embodiment. FIG. 4 illustrates a hood 21 to be attached to the LED lamp 20. The hood 21 has a rear end formed with two hook pieces 21a which are located symmetrically with respect to a center line or an axis of the hood 21. Each hook piece 21a includes a tapered surface 21b and a stepped portion 21c continuous to the tapered surface 21b. Each hook piece 21a has a thickness that is gradually increased from the rear end to the front end side by the tapered surface 21b. Each hook piece 21a has both sides formed with respective slits 21d so that each hook piece 21a is flexed radially outward with respect to the hood 21.

The other configuration of the LED lamp 20 according to the second embodiment is similar to that of the LED lamp 10 according to the first embodiment. Accordingly, identical or similar parts in the second embodiment are labeled by the same reference symbols as those in the first embodiment, and detailed description of these parts will be eliminated.

In the LED lamp 20 according to the second embodiment, the hood 21 is attached to the open end 11d of the cup-shaped portion 11b from the rear end side of the housing 11 or the cup-shaped portion 11b side. When the hood 21 is to be attached from the cup-shaped portion 11b side, the tapered surface 21b of each hook piece 21a is pressed against the flange 11e. With this, each hook piece 21a is flexed radially outward with respect to the hood 21. Accordingly, the tapered surface 21b is caused to pass by the flange 11e with the result that the stepped portion 21c of each hook piece 21a engages the flange 11e.

According to the second embodiment, the stepped portion 21c of each hook piece 21a engages the flange 11e when the hood 21 is moved forward. Accordingly, the hood 21 can be prevented from dropping off from the open end 11d of the cup-shaped portion 11b. Furthermore, the hood 21 can be detached from the housing 11 when moved rearward. Still furthermore, the hood 21 can be attached to the open end 11d of the cup-shaped portion 11b from the cup-shaped portion 11b side as well as from the rear end side of the housing 11. Consequently, attachment and detachment of the hood can be carried out more easily.

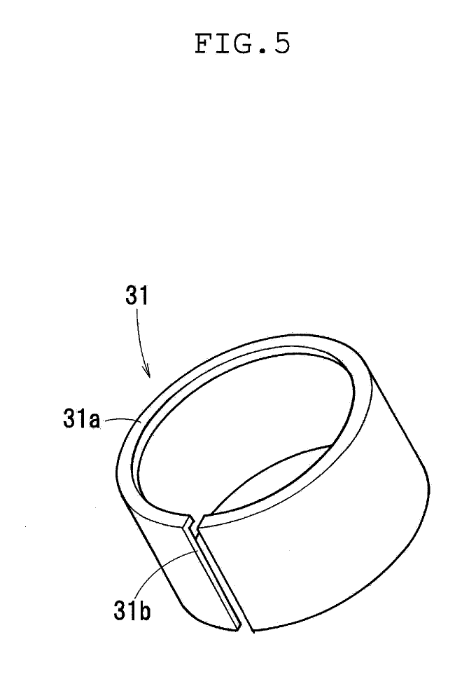

FIG. 5 illustrates a hood 31 to be attached to an LED lamp 30 according to a third embodiment. The hood 31 is an elastic opaque resin molding and is formed so that an inner diameter thereof is slightly smaller than an outer diameter of the flange 11e. The hood 31 has a rear end formed with a ring-shaped hook piece 31a in the same manner as the hood 12 of the LED lamp 10 of the first embodiment. Furthermore, the hood 31 has a ring-shaped rear end having a periphery thereof formed with a slit 31b extending in parallel to the center line of the hood 31. Since the periphery of the hood 31 is divided by the slit 31b, the hood 31 can be spread radially outward against the elastic force.

Since the hood 31 is spreadable, it can be attached to the open end 11d of the cup-shaped portion 11b from the open end 11d side as well as from the rear end side of the housing 11. The hood 31 which has been spread and attached to the open end 11d is pressed against the outer periphery of the flange 11e of the open end 11d by the self elasticity. Consequently, the hood 31 can be attached to the open end 11d so as to be movable forward and rearward and rotatable without being rickety.

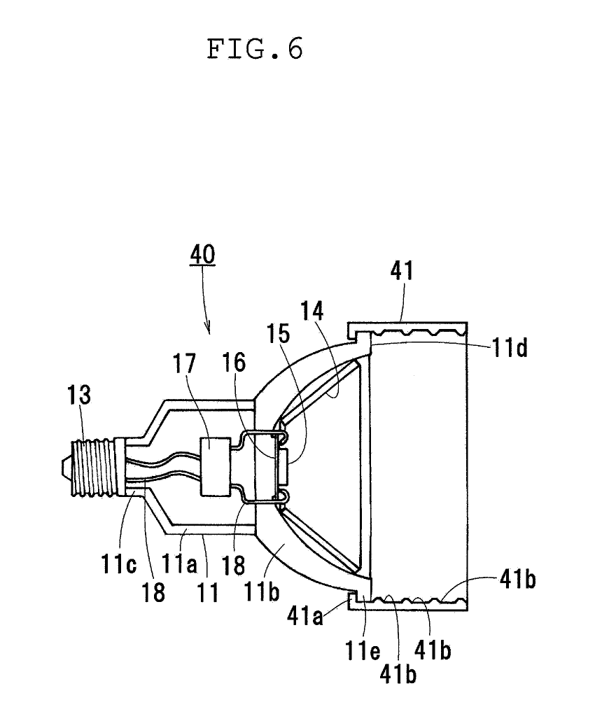

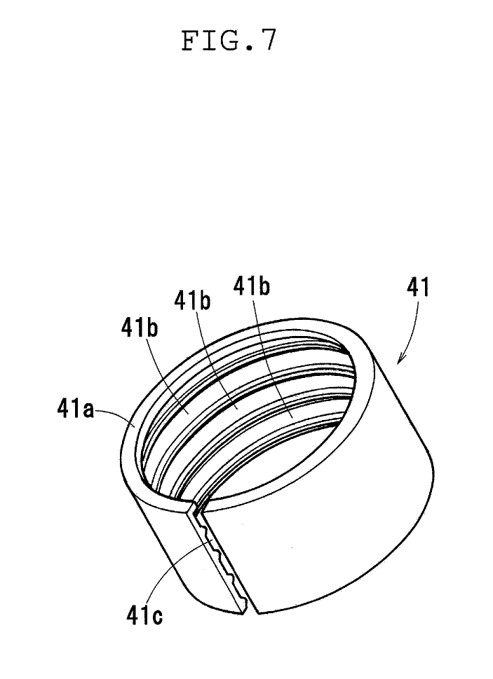

FIG. 6 illustrates an LED lamp 40 according to a fourth embodiment and FIG. 7 illustrates a hood 41 to be attached to the LED lamp 40. The hood 41 has a rear end having a ring-shaped hook piece 41a protruding radially inward. The hood 41 has an inner periphery formed with a plurality of ring grooves 41b extending in parallel in the front-rear direction with respect to the hood 41. The hood 41 also has a peripheral surface formed with a slit 41c so that the hood 41 is spreadable radially outward.

The other configuration of the LED lamp 40 according to the fourth embodiment is similar to that of the LED lamp 10 according to the first embodiment. Accordingly, identical or similar parts in the fourth embodiment are labeled by the same reference symbols as those in the first embodiment, and detailed description of these parts will be eliminated.

In the LED lamp 40 according to the fourth embodiment, the hood 41 is attached to the housing 11 from the rear end side of the housing 11. Alternatively, the hood 41 is spread and attached to the open end 11d of the cup-shaped portion 11b from the cup-shaped portion 11b side.

According to the fourth embodiment, when the hood 41 is moved forward, the hook piece 41a engages the flange 11e at the forward end of the hood 41. Consequently, the hood 41 can be prevented from dropping off from the open end 11d of the cup-shaped portion 11b. Furthermore, the hood 41 can be attached to the housing 11 from the rear end side of the housing 11. Alternatively, the hood 41 is spread and can be attached to the housing 11 from the cup-shaped portion 11b side. Consequently, attachment and detachment of the hood 41 can be carried out more easily. Still furthermore, the flange 11e is fitted into any one of the ring grooves 41b when the hood 41 is moved forward and rearward, whereby the hood 41 is positioned. Consequently, the position of the hood 41 can easily be adjusted in the front-rear direction.

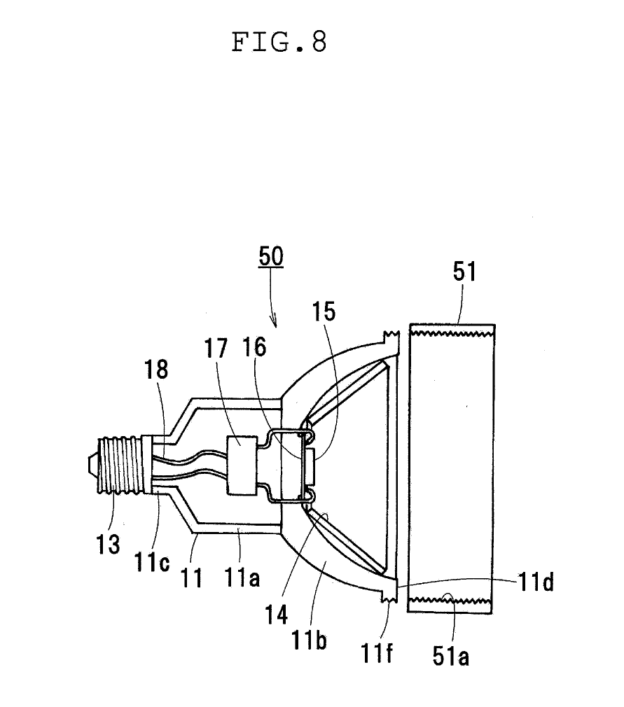

FIG. 8 illustrates an LED lamp 50 according to a fifth embodiment. The open end 11d of the cup-shaped portion 11d has an outer periphery formed with a male thread 11f. On the other hand, a hood 51 has an inner periphery formed with a female thread 51a which is threadingly engageable with the male thread 11f. The female thread 51a of the hood 51 is threadingly engaged with the male thread 11f of the open end 11d of the cup-shaped portion 11b, whereby the hood 51 is attached to the open end 11d of the cup-shaped portion 11b so as to be movable forward and rearward and rotatable.

The other configuration of the LED lamp 50 according to the fifth embodiment is similar to that of the LED lamp 10 according to the first embodiment. Accordingly, identical or similar parts in the fifth embodiment are labeled by the same reference symbols as those in the first embodiment, and detailed description of these parts will be eliminated.

According to the fifth embodiment, the hood 51 is threadingly engageable with the open end 11d of the cup-shaped portion 11b. Consequently, attachment and detachment of the hood 51 can be carried out more easily. Furthermore, the position of the hood 51 can be fine-adjusted in the front-rear direction by the male thread 11f and the female thread 51a.

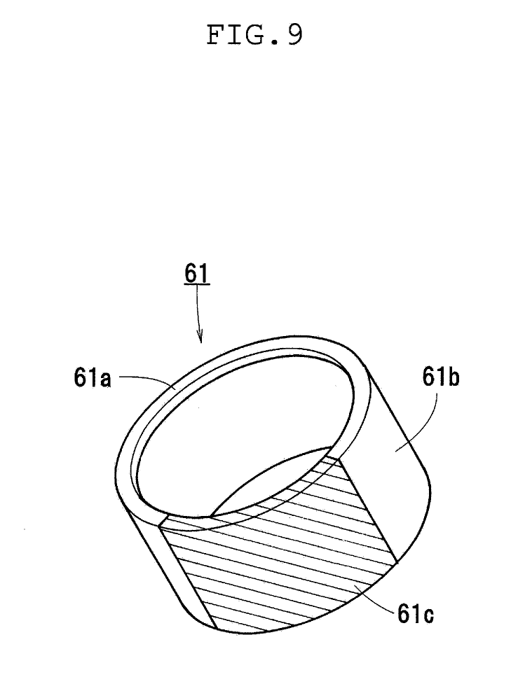

FIG. 9 illustrates a hood 61 to be attached to a LED lamp according to the sixth embodiment. The hood 61 has a rear end formed with a ring-shaped hook piece 61a and a peripheral surface including a transparent portion 61b and an opaque portion 61c.

The other configuration of the LED lamp 60 according to the sixth embodiment is similar to that of the LED lamp 10 according to the first embodiment.

According to the sixth embodiment, the position of the hood 61 in the front-rear direction can be adjusted and a rotational position of the transparent portion 61b of the hood 6 can also be adjusted by rotating the hood 61. Consequently, an amount of light emitted from the cup-shaped portion 11b of the LED lamp 60 can be adjusted and a direction in which the light is emitted from the cup-shaped portion 11b can also be adjusted.

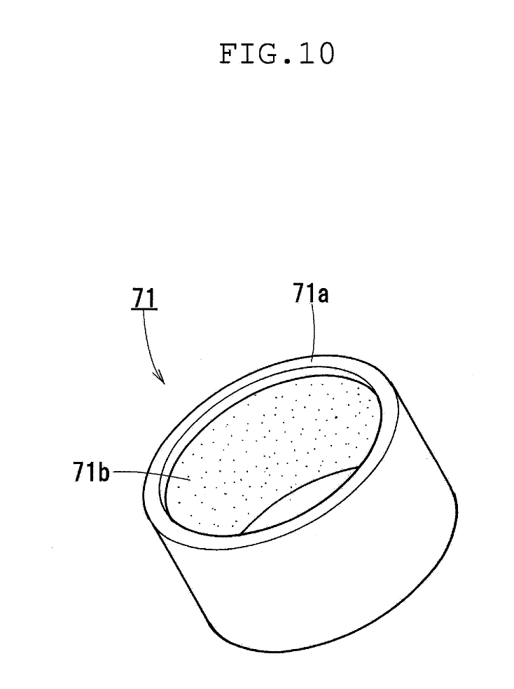

FIG. 10 illustrates a hood 71 to be attached to an LED lamp 70 according to a seventh embodiment. The hood 71 is a transparent or translucent resin molding and has a rear end formed with a ring-shaped hook piece. The hood 71 has an inner periphery formed with a shallow pearskin-finished concavo-convex surface 71b formed by embossing. As a result, light emitted from the LED chip is diffusely reflected on the inner peripheral surface 71b of the hood 71 such that the light is emitted around the LED lamp 70 through the hood 71. Consequently, gorgeousness can be created by the emitted light.

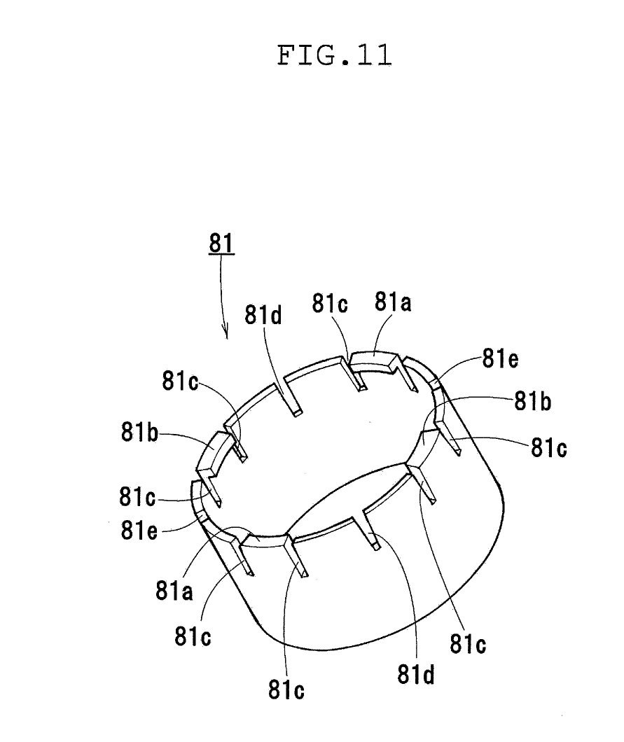

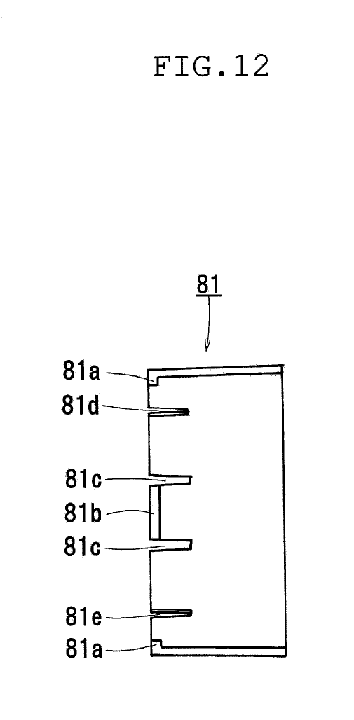

FIGS. 11 and 12 illustrate a hood 81 to be attached to an LED lamp 80 according to an eighth embodiment. The hood 81 has a rear end formed with two pairs of hook pieces 81a and 81b all protruding radially inward with respect to the hood 81. In each pair, the hook pieces 81a and 81b are disposed symmetrically with respect to a center line or axis of the hood 81. Each hook piece 81a, 81b has both sides formed with respective slits 81c. Furthermore, two pairs of slits 81d and 81e are formed between the hook pieces 81a and 81b respectively. Each pair of the slits 81d and 81e is disposed symmetrically with respect to the center line of the hood 81.

In the LED lamp 80 according to the eighth embodiment, the hood 81 attached to the housing 11 from the rear end side or the portions of the paired slits 81d and 81e are externally pressed. With this, a distance between the hook pieces 81a and 81b of each pair is increased. Accordingly, the hood 81 can be attached to the open end 11d of the cup-shaped portion 11b from the cup-shaped portion 11b side. Since the hook pieces 81a and 81b of the attached hood 81 engage the flange 81e at the forward end of the hood 81, the hood 81 can be prevented from dropping off from the open end 11d of the cup-shaped portion 11b.

According to the eighth embodiment, the hood 81 can be attached to the open end 11d of the cup-shaped portion 11b not only from the rear end side of the housing 11 but also from the cup-shaped portion 11b side. Consequently, attachment and detachment of the hood 81 can be carried out more easily.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An LED lamp comprising:
a housing having a front end side formed into a cup shape and a rear end to which a cap is fixed, the cup-shaped portion having an inner peripheral surface formed with a reflection layer and an open end;
a cap fixed to the rear end of the housing;
an LED chip fixed to a bottom of the cup-shaped portion;
a lighting circuit incorporated in the housing to supply electric power to the LED chip, the lighting circuit and the cap being electrically connected to each other; and
a hood which is attached to the open end of the cup-shaped portion so as to be movable forward and rearward in a direction of an imaginary center line of the cup-shaped portion.

2. The LED lamp according to claim 1, wherein:
the open end of the cup-shaped portion has a flange protruding radially outward with respect to the cup-shaped portion;
the hood has a rear end formed with a hook piece protruding radially inward with respect to the hood;
the hood is attached to the open end of the cup-shaped portion of the housing from the rear end side of the housing; and
the hook piece is configured to engage the flange at a forward end thereof.

3. The LED lamp according to claim 1, wherein:
the open end of the cup-shaped portion has a flange protruding radially outward with respect to the cup-shaped portion;
the hood has a rear end formed with a plurality of hook pieces which protrudes radially inward with respect to the hood and which is opposed to each other, each hook piece including a tapered surface and stepped portion continuous to the tapered surface;
each hook piece has two opposite sides formed with respective slits so that each hook is flexed in an outward direction of the hood when the hood is mounted from the cup-shaped portion thereby to be pressed against the flange;
the hood is mounted to the housing from the cup-shaped portion side; and
each hook piece is configured to engage the flange at a forward end thereof.

4. The LED lamp according to claim 1, wherein:
the open end of the cup-shaped portion has a flange projecting radially outward with respect to the cup-shaped portion;
the hood has a rear end formed with a hook piece which protrudes radially inward with respect to the hood;
the hood has a periphery formed with a slit so as to be radially spread;
the hood is attached from the rear end side of the housing or from the cup-shaped portion side by spreading the hood; and
each hook piece is configured to engage the flange at a forward end thereof.

5. The LED lamp according to claim 1, wherein:
the open end of the cup-shaped portion has a flange projecting radially outward with respect to the cup-shaped portion;
the hood has a rear end formed with a hook piece which protrudes radially inward with respect to the hood;
the hood has an inner periphery formed with a plurality of ring grooves extending in parallel in a front-rear direction with respect to the hood, the inner periphery of the hood also being formed with a slit so that the hood is spread radially outward;
the hood is attached from the rear end side of the housing or from the cup-shaped portion side by spreading the hood; and
the hook piece is configured to engage the flange at a forward end of the hood, and the flange is configured to be fitted into any one of the ring grooves when the hood is moved forward or rearward, whereby the hood is positioned.

6. The LED lamp according to claim 1, wherein:
the open end of the cup-shaped portion has an outer periphery formed with a male thread;
the hood has an inner periphery formed with a female thread; and
the female thread of hood is threadingly engaged with the male thread of the open end of the cup-shaped portion, whereby the hood is mounted to the open end of the cup-shaped portion so as to be movable forward or rearward.

7. The LED lamp according to claim 1, wherein the hood is rotatably mounted to the open end of the cup-shaped portion and the hood has a periphery formed with a transparent portion and an opaque portion.

8. The LED lamp according to claim 1, wherein the hood is formed of a transparent or translucent resin and has an inner periphery that is embossed.

9. The LED lamp according to claim 1, wherein:
the open end of the cup-shaped portion has a flange protruding radially outward with respect to the cup-shaped portion;
the hood has a rear end formed with a pair of hook pieces which are formed so as to protrude radially inward with respect to the hood and so as to be symmetric with respect to an imaginary center line of the hood;
the hood has a plurality of slits formed at both sides of each hook piece and between the hook pieces;
the hood is attached to the open end of the cup-shaped portion from the rear end side of the housing or from the cup-shaped portion side by externally pressing two opposite portions of a periphery of the hood so that a distance between the hooks is increased; and
each hook piece is configured to engage the flange at a forward end of the hood.
